(19) United States
(12) Patent Application Publication
(10) Pub. No.: US 2016/0133382 A1
(43) Pub. Date: May 12, 2016

(54) Stationary Induction Apparatus

(71) Applicant: Hitachi, Ltd., Tokyo (JP)

(72) Inventors: Sho SUGIYAMA, Tokyo (JP); Akira YAMAGISHI, Tokyo (JP); Ryoji HIROBE, Tokyo (JP); Taku OYAMA, Tokyo (JP)

(21) Appl. No.: 14/927,784

(22) Filed: Oct. 30, 2015

(30) Foreign Application Priority Data
Nov. 6, 2014 (JP) 2014-225667

(51) Int. Cl. H01F 27/33; H01F 27/02

(52) U.S. Cl. CPC H01F 27/33; H01F 27/02

(57) ABSTRACT

Provided is a stationary induction apparatus capable of sufficiently decreasing noise and preventing rainwater and dust from entering between welded portions even when using a method of mounting a sound insulating board between an upper stay and a lower stay. The stationary induction apparatus of the present invention includes a stationary induction apparatus main body, a tank, an upper stay and a lower stay, and a sound insulating board. The tank houses the stationary induction apparatus main body and an insulating material. Each of the upper stay and the lower stay is provided respectively, at least at each of an upper portion and a lower portion of an outer surface of the tank. The sound insulating board is disposed between the upper stay and the lower stay. The sound insulating board is partially weld-joined, at each of both ends, with a supporting member, and a sealing material is provided at an outer periphery of a welded portion of the sound insulating board.

### TECHNICAL FIELD

The present invention relates to a stationary induction apparatus, particularly relates to the stationary induction apparatus that is suitable for a situation in which, for example, a sound insulating board is provided on an outer surface of a tank so as to reduce noise occurring from a main body of the stationary induction apparatus such as a transformer and a reactor.

### BACKGROUND ART

In recent years, as urban areas are expanding, more and more residential areas are built in proximity to a substation, or the like. Along with this trend, noise-reduction requirements for a stationary induction apparatus including a transformer and a reactor are becoming more stringent.

Noise due to the stationary induction apparatus is classified into the noise occurring in a core of the stationary induction apparatus main body and the noise occurring in auxiliaries such as an air blower and an oil transfer pump of a cooler. Among the noise, electromagnetic vibration due to core magnetostriction is transmitted to a tank via an insulating material such as an insulation oil and gas. The vibration transmitted to the tank is emitted to the outside as noise. Energy of this noise caused by the electromagnetic vibration makes up a large ratio of the entire noise emitted from the stationary induction apparatus. To solve this problem, various preventive measures have been taken.

For example, there is a method of enclosing the stationary induction apparatus with a noise protection housing made of concrete or an iron plate so as to block or absorb the noise. Another method to easily decrease the noise emitted from the tank is to provide a sound insulating board between an upper stay and a lower stay arranged on an outer surface of the tank.

The typical stationary induction apparatus employs a method of blocking or absorbing the noise of the stationary induction apparatus by using the noise protection housing made of concrete or an iron plate.

The stationary induction apparatus is configured to include a tank. The tank internally houses a stationary induction apparatus main body including a core and winding around the core. The tank is filled with an insulating material such as insulating oil and gas for cooling the stationary induction apparatus main body. To a side plate that constitutes the tank, an upper stay and a lower stay are fixed to reinforce the strength of the side plate.

In the stationary induction apparatus with this configuration, when the core is excited, electromagnetic vibration occurs on the core. This electromagnetic vibration, due to its insulating material having a substantially non-compressible characteristic, is transmitted to the tank with very little attenuation and causes the tank to generate noise. To decrease this noise, a noise protection housing made of concrete or an iron plate is built enclosing the tank, so as to block or absorb the noise emitted from the tank.

PTL 1 discloses a method for mounting a sound insulating board between the upper stay and the lower stay provided on an outer surface of the tank so as to decrease the noise emitted from the tank.

In this method disclosed in PTL 1, in order to reinforce strength of the side plate that constitutes the tank, the sound insulating board made of a damping steel plate is installed at a space enclosed with the upper stay and the lower stay fixed to the side plate, via a thin steel plate as an elastic body. This method is intended to block and decrease, at the sound insulating board, the noise emitted from the tank by using an elastic effect of a spring element of the thin steel plate and a damping action of the damping steel plate.

### CITATION LIST

### Patent Literature

PTL 1: JP 2000-340432 A

### SUMMARY OF INVENTION

### Technical Problem

The above-mentioned conventional technique of enclosing the stationary induction apparatus with the noise protection housing built with concrete or an iron plates to block or absorb the noise, however, requires placement of foundation for a concrete or iron plate structure. This would encounter various problems including an increase in an installation area of the stationary induction apparatus, higher production costs, and a lengthened construction period.

Moreover, the method, to solve these problems, of mounting a sound insulating board between the upper and lower stays arranged on the outer surface of the tank has a problem. That is, if the sound insulating board is welded entirely with the upper and lower stays (whole-periphery welding), it is difficult to sufficiently block the noise transmitted from a welded portion, leading to a failure sufficiently decreasing the noise. To avoid this, however, if the sound insulating board is welded partly, instead of entirely, it might allow rainwater and dust to enter through a gap between welded portions.

In view of the above-described points, an object of the present invention is to provide a stationary induction apparatus that can sufficiently decrease the noise and prevent rainwater and dust from entering between the welded portions even when using a method of mounting the sound insulating board between the upper and lower stays.

### Solution to Problem

A stationary induction apparatus of the present invention includes: a stationary induction apparatus main body; a tank for housing the stationary induction apparatus main body and an insulating material; an upper stay and a lower stay, provided, respectively, at least at each of an upper portion and a lower portion of an outer surface of the tank, and a sound insulating board disposed between the upper stay and the lower stay, wherein the sound insulating board is partially weld-joined, at each of both ends, with a supporting member, and a sealing material is provided at an outer periphery of a welded portion of the sound insulating board.

### Advantageous Effects of Invention

According to the present invention, it is possible to sufficiently decrease the noise and prevent rainwater and dust from entering between the welded portions even when using a method of mounting the sound insulating board between the upper and lower stays.

### BRIEF DESCRIPTION OF DRAWINGS

FIG. 1 is a front view of a transformer as an exemplary stationary induction apparatus of the present invention.

FIG. 2 is a front view of another exemplary transformer as an exemplary stationary induction apparatus of the present invention.

FIG. 3 is a first exemplary embodiment of a stationary induction apparatus of the present invention and illustrates a detailed mounting state of a sound insulating board mounted to a tank of a transformer.

FIG. 4 is a second exemplary embodiment of the stationary induction apparatus of the present invention and illustrates a detailed mounting state of the sound insulating board mounted to the tank of the transformer.

FIG. 5 is a third exemplary embodiment of the stationary induction apparatus of the present invention and illustrates a detailed mounting state of the sound insulating board mounted to the tank of the transformer.

### DESCRIPTION OF EMBODIMENTS

Hereinafter, a stationary induction apparatus according to the present invention will be described with reference to exemplary embodiments illustrated in the drawings. In each of the drawings described below, the same reference sign will be used for the same component.

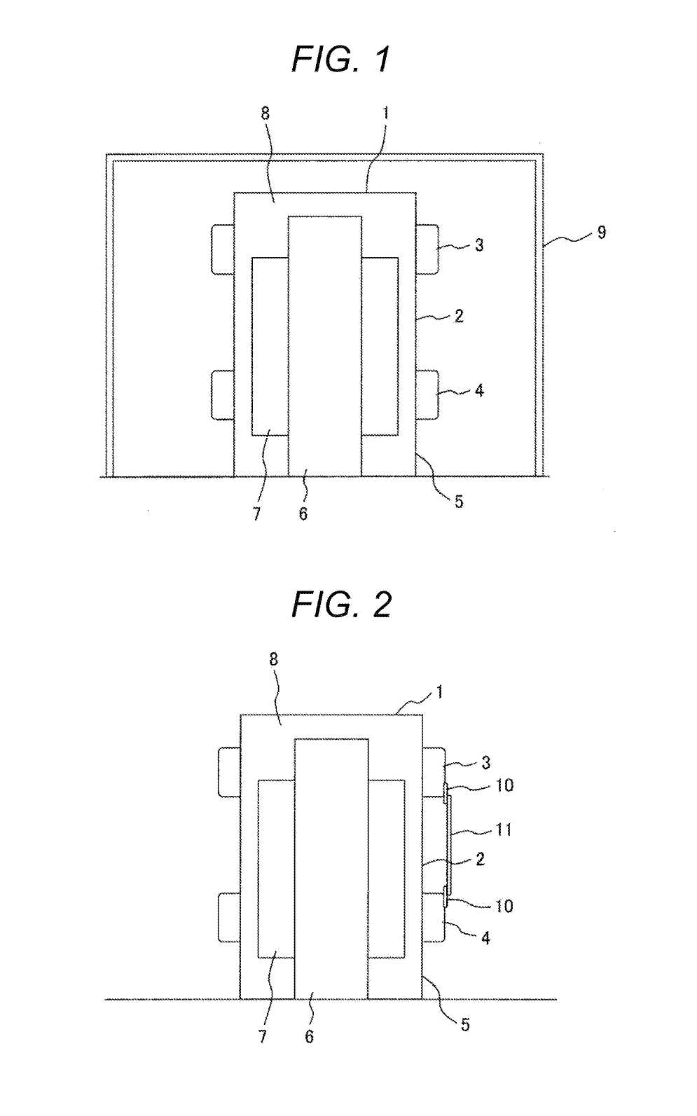

Before describing the exemplary embodiments of the present invention, an entire configuration of a transformer as an exemplary stationary induction apparatus will be described with reference to FIGS. 1 and 2.

FIG. illustrates, as an exemplary configuration of the transformer, a method of blocking or absorbing noise from the transformer by enclosing the transformer with a noise protection housing made of concrete or an iron plate.

In FIG. 1, a reference sign 1 denotes a tank 1. The tank 1 internally houses a transformer 5, which is an apparatus main body configured with a core 6 and winding 7 wound around the core 6. An inside of the tank 1 is filled with an insulating material 8 such as insulation oil and gas, for cooling the transformer 5. A reference sign 2 denotes a side plate 2 that constitutes the tank 1. To this side plate 2, an upper stay 3 and a lower stay 4 are fixed to reinforce the strength of the side plate 2.

In the transformer with this configuration, when the core 6 is excited, electromagnetic vibration occurs on the core 6. This electromagnetic vibration, due to the insulating material 8 having a substantially non-compressible characteristic, is transmitted to the tank 1 with very little attenuation, causing the tank 1 to generate noise. To decrease this noise, a noise protection housing 9 is built of concrete or an iron plate enclosing the tank 1, so as to block or absorb the noise emitted from the tank 1.

The configuration of the transformer illustrated in FIG. 1, however, requires placement of foundation for building a concrete or iron plate structure. This would encounter various problems including an increase in an installation area of the transformer, higher production cost, and a lengthened construction period.

An exemplary configuration illustrated in FIG. 2 is a method for mounting a sound insulating board 11 between the upper stay 3 and the lower stay 4 each provided on an outer surface of the tank 1 so as to decrease the noise emitted from the tank 1. In this method, in order to reinforce the strength of the side plate 2 that constitutes the tank 1, the upper stay 3 and the lower stay 4 are fixed to the side plate 2. The sound insulating board 11 made of a damping steel plate is installed at a space enclosed with the upper stay 3 and the lower stay 4, via a thin steel plate 10 as an elastic body. This method is intended to block and decrease, at the sound insulating board 11, the noise emitted from the tank 1 by using an elastic effect of a spring element of the thin steel plate 10 and a damping action of the damping steel plate.

The configuration of the transformer illustrated in FIG. 2, however, has a problem. That is, if the sound insulating board 11 is welded entirely with the upper and lower stays 3 and 4 (whole-periphery welding), it is difficult to sufficiently block the noise transmitted from a welded portion, leading to a failure in sufficiently decreasing the noise.

The present invention is intended to solve these problems, and details will be described along each of exemplary embodiments.

### First Exemplary Embodiment

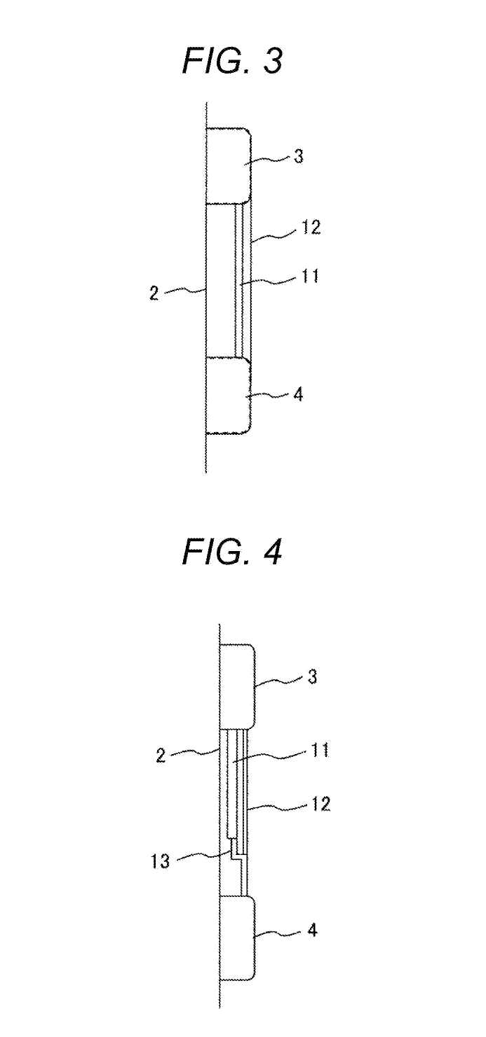

FIG. 3 illustrates a transformer as a first exemplary embodiment of a stationary induction apparatus of the present invention and illustrates a detailed mounting state of a sound insulating board mounted to a tank of the transformer.

In the present embodiment, as illustrated in FIG. 3, a sound insulating board 11 is partially weld-joined (spotwise) at each of both ends, with each of upper and lower stays 3 and 4. In addition, a sealing material 12 made of iron is provided at an outer periphery of a welded portion. The sealing material 12 is provided so as to include the outer periphery of the welded portion and to cover an outer surface whole periphery of the sound insulating board 11. Moreover, the sealing material 12 is entirely weld-joined (whole-periphery welding), at each of both ends, with each of the upper and lower stays 3 and 4.

In other words, in the present exemplary embodiment illustrated in FIG. 3, installation is performed such that the sound insulating board 11 is partially welded with the upper and lower stays 3 and 4. In addition, the sealing material 12 is entirely weld-joined (whole-periphery welding) with the upper and lower stays 3 and 4, and is arranged so as to cover the outer surface whole periphery of the sound insulating board 11.

According to the above-configured exemplary embodiment, it is possible to prevent various problems such as an increase in an installation area of the stationary induction apparatus, higher production cost, and a lengthened construction period, from occurring in the noise protection housing made of concrete or an iron plate. It is also possible to provide a sufficient area for installing the sound insulating hoard 11 and to sufficiently decrease the noise. Moreover, by covering the outer surface whole periphery of the sound insulating board 11 with the sealing material 12, it is possible to prevent rainwater and dust from entering between the welded portions even when partial welding (spotwise) is implemented.

### Second Exemplary Embodiment

FIG. 4 illustrates a transformer that is a second exemplary embodiment of the stationary induction apparatus of the present invention and illustrates a detailed mounting state of the sound insulating board mounted to the tank of the transformer.

In the present exemplary embodiment, as illustrated in FIG. 4, an upper end of the sound insulating board 11 is partially joined (spotwise) with an upper end stay 3 and a lower end of the sound insulating board 11 is partially weld-joined (spotwise) to a connecting member 13. The connecting member 13 is entirely weld-joined (whole-periphery welding) with a lower end stay 4, and the sealing material 12 made of iron is provided on an outer periphery of a welded portion of the sound insulating board 11. Furthermore, the sealing material 12 is provided so as to include the outer periphery of the welded portion and to cover an outer surface whole periphery of the sound insulating board 11. In addition, an upper end of the sound insulating board 11 is entirely weld-joined (whole-periphery welding) with the upper end stay 3, and a lower end of the sound insulating board 11 is entirely weld-joined (whole-periphery welding) with the connecting member 13.

In other words, in the present exemplary embodiment illustrated in FIG. 4, an end of the sound insulating board 11 is partially weld-joined (spotwise) with the upper stay 3, another end being partially weld-joined with the connecting member 13, and the connecting member 13 and the lower stay 4 being entirely weld-joined (whole-periphery welding) with each other. Furthermore, by implementing an entire weld-joining (whole-periphery welding) for an end of the sealing material 12 with the upper stay 3, and for another end of the sealing material 12 with the connecting member 13, it is possible to provide a structure that, even in rain, can prevent rainwater from entering an inside of a noise protection structure of the sound insulating board 11. At the same time, installation is performed such that the sealing material 12 covers the outer surface whole periphery of the sound insulating board 11.

With this configuration of the present exemplary embodiment, it is also possible to obtain similar effects obtained with the exemplary embodiment 1. In addition, by implementing entire welding (whole periphery welding) of the sealing material 12, it is possible to prevent rainwater and dust more reliably from entering between welded portions.

### Third Embodiment

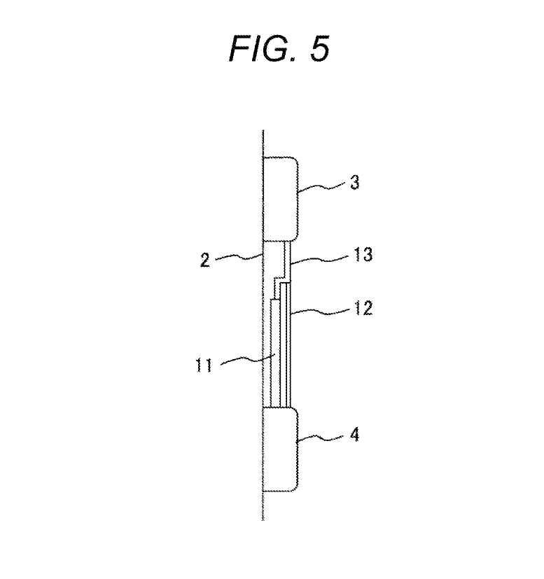

FIG. 5 illustrates a transformer that is a third exemplary embodiment of the stationary induction apparatus of the present invention and illustrates a detailed mounting state of the sound insulating board mounted to the tank of the transformer.

In the present exemplary embodiment, as illustrated in FIG. 5, a lower end of the sound insulating hoard 11 is partially joined (spotwise) with the lower end stay 4 and an upper end of the sound insulating board 11 is partially weld-joined (spotwise) with a connecting member 13. The connecting member 13 is entirely weld-joined (whole-periphery welding) with the upper end stay 3, and the sealing material 12 made of iron is provided on an outer surface whole periphery of a welded portion of the sound insulating board 11. Furthermore, the sealing material 12 is provided so as to include the outer periphery of the welded portion and to cover the outer surface whole periphery of the sound insulating board 11. In addition, a lower end of the sealing material 12 is entirely weld-joined (whole-periphery welding) with the lower end stay 4, and an upper end of the sealing material 12 is entirely weld-joined (whole-periphery welding) with the connecting member 13.

In other words, in the present exemplary embodiment illustrated in FIG. 5, an end of the sound insulating board 11 is partially weld-joined (spotwise) with the lower stay 4, another and being partially weld-joined with the connecting member 13, and the connecting member 13 and the upper stay 3 being entirely weld-joined (whole-periphery welding) with each other. Furthermore, by implementing an entire weld-joining (whole-periphery welding) for an end of the sealing material 12 with the lower stay 4, and for another end of the sealing material 12 with the connecting member 13, it is possible to provide a structure that, even when rust is generated on the sealing material 12 due to deterioration over time, can prevent rainwater from entering an inside of a noise protection structure. At the same time, installation is performed such that the sealing material 12 covers an outer surface whole periphery of the sound insulating board 11.

With this configuration of the present exemplary embodiment, it is also possible to obtain similar effects obtained with the exemplary embodiment 1. In addition, by implementing entire welding (whole periphery welding) of the sealing material 12, it is possible to prevent rainwater and dust more reliably from entering between welded portions.

The present invention is not limited to the above-described exemplary embodiments and may include various exemplary modifications. The above-described exemplary embodiments are given for achieving easy understanding of the present invention and are not necessarily limited to examples with all of the configurations described herein. Furthermore, part of a configuration of an exemplary embodiment may be replaced with a configuration with another exemplary embodiment. A configuration of an exemplary embodiment may additionally include a configuration of another exemplary embodiment. Furthermore, for each of the exemplary embodiments, part of a configuration can he added, deleted, and be replaced with another configuration.

### REFERENCE SIGNS LIST

1 tank
2 side plate
3 upper stay
4 lower stay
5 transformer
6 core
7 winding
8 insulating material
9 noise protection housing
10 thin steel plate
11 sound insulating board
12 sealing material
13 connecting member

1. A stationary induction apparatus comprising:
a stationary induction apparatus main body;
a tank for housing the stationary induction apparatus main body and an insulating material;
an upper stay and a lower stay, provided, respectively, at least at each of an upper portion and a lower portion of an outer surface of the tank, and
a sound insulating board disposed between the upper stay and the lower stay,
wherein the sound insulating board is partially weld-joined, at each of both ends, with a supporting member, and a sealing material is provided at an outer periphery of a welded portion of the sound insulating board.

2. The stationary induction apparatus according to claim 1,
wherein the sound insulating board is partially weld-joined, at each of the both ends, with each of the upper stay and the lower stay, and the sealing material is provided so as to include the outer periphery of the welded portion and to cover a whole periphery of the sound insulating board.

3. The stationary induction apparatus according to claim 2,
wherein the sealing material is entirely weld-joined, at each of the both ends, with each of the upper stay and the lower stay.

4. The stationary induction apparatus according to claim 1,
wherein an upper end of the sound insulating board is partially weld-joined with the upper end stay, a lower end of the sound insulating board is partially weld-joined with a connecting member, the connecting member and the lower end stay are entirely weld-joined wart each other, and the sealing material is provided at the outer periphery of the welded portion of the sound insulating board.

5. The stationary induction apparatus according to claim 4,
wherein the sealing material is provided so as to include the outer periphery of the welded portion and to cover a whole periphery of the sound insulating board, an upper end of the sealing material is entirely weld-joined with the upper end stay, and a lower end of the sealing material is entirely weld-joined with the connecting member.

6. The stationary induction apparatus according to claim 1,
wherein a lower end of the sound insulating board is partially weld-joined with the lower end stay, an upper end of the sound insulating board is partially weld-joined with a connecting member, the connecting member and the upper end stay are entirely weld-joined with each other, and the sealing material is provided at the outer periphery of the welded portion of the sound insulating board.

7. The stationary induction apparatus according to claim 6,
wherein the sealing material is provided so as to include the outer periphery of the welded portion and to cover a whole periphery of the sound insulating board, an lower end of the sealing material is entirely weld-joined with the lower end stay, and an upper end of the sealing material is entirely weld-joined with the connecting member.
